(19) United States
(12) Patent Application Publication
(10) Pub. No.: US 2008/0268235 A1
(43) Pub. Date: Oct. 30, 2008

(54) LIGHT DIFFUSER PLATE

(75) Inventors: Shinya KIMURA, Niihama-shi (JP); Toyohiro Hamamatsu, Niihama-shi (JP); Masanori Tamada, Niihama-shi (JP); Takashi Sakamoto, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/107,903

(22) Filed: Apr. 23, 2008

(30) Foreign Application Priority Data
Apr. 25, 2007 (JP) 2007-115223
Aug. 20, 2007 (JP) 2007-213416

(51) Int. Cl. G02F 1/361; B32B 5/16

(52) U.S. Cl. 428/327; 252/582

(57) ABSTRACT

A light diffuser plate comprising a transparent resin composition containing a transparent resin and a light diffuser in which the light diffuser has an average particle diameter of from 0.6 μm to 1.5 μm and a standard deviation of particle diameters of from 0.01 μm to 0.5 μm, and an absolute value of a refractive index difference |Δn| between the transparent resin and the light diffuser is at least 0.05.

### FIELD OF THE INVENTION

The present invention relates to a light diffuser plate.

### BACKGROUND ART

As shown in FIG. 1, a color liquid crystal display comprises an image display (4) and a light source (5) which illuminates the image display (4) from the back face side thereof, and is widely used as a display of a liquid crystal television and so on. The image display (4) usually comprises a liquid crystal cell (1), polarizing sheets (2) which are provided on the respective sides of the crystal cell (1), and a color filter (3) which colors transmitting light passing through the liquid crystal cell to display colored images. On a light path between the light source (5) and the image display (4), a light diffuser plate (6) is provided for uniformly illuminating the image display (4) with light emitted from cold cathode fluorescent lamps (5) (JP-A-2001-305335).

As the light diffuser plate (6), a light diffuser plate made of a resin composition comprising a transparent resin as polystyrene and a light diffuser is usually used, and a light diffuser plate which can sufficiently diffuse transmitted light with a small amount of the light diffuser is sought.

### SUMMARY OF THE INVENTION

An object of the present invention is to provide a light diffuser plate which has a high light diffusing property with a smaller amount of a light diffuser.

Accordingly, the present invention provides a light diffuser plate comprising a transparent resin composition which comprises a transparent resin and a light diffuser wherein the light diffuser has an average particle diameter of from 0.6 μm to 1.5 μm and a standard deviation of particle diameters of from 0.01 μm to 0.5 μm, and an absolute value of a refractive index difference |Δn| between the transparent resin and the light diffuser is at least 0.05.

The light diffuser plate of the present invention attains a high light diffusing property with the small amount of the light diffuser. Thus, the amount of the light diffuser can be decreased, or the thickness of the light diffuser plate can be reduced.

### BRIEF DESCRIPTION OF THE DRAWINGS

FIG. 1 is a schematic cross sectional view of an example of a color liquid crystal display.

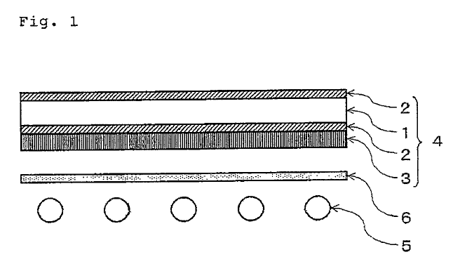

### DETAILED DESCRIPTION OF THE INVENTION

As the transparent resin used in the light diffuser plate of the present invention, any transparent resin that is used in conventional light diffuser plates may be used. Examples of the transparent resin include styrenic resins, polymethyl methacrylate, polycarbonate, cycloolefin polymers, cycloolefin copolymers, polypropylene, etc.

The styrenic resin used in the present invention comprises from 50 to 100% by weight of styrenic monomer units based on the whole weight of the styrenic resin. Examples of the styrenic monomer include styrene and substituted styrenes. Examples of the substituted styrenes include halogenated styrenes such as chlorostyrene, bromostyrene, etc.; alkyl-substituted styrenes such as vinyltoluene, α-methylstyrene, etc.; and the like. The styrenic monomers may be used independently or in a combination of two or more of them.

From the viewpoint of resistance to moisture absorption, preferable transparent resins used in the present invention are polystyrene, styrene-methyl methacrylate copolymers, cycloolefin polymers and copolymers and polypropylene. In particular, polystyrene is preferable.

From the viewpoint of heat resistance, preferable transparent resins used in the present invention are styrenic monomer-methacrylic acid copolymers. Here, the styrenic monomer-methacrylic acid copolymer means a copolymer prepared by copolymerizing a styrenic monomer and methacrylic acid. The content of the styrenic monomer units in the styrenic monomer-methacrylic acid copolymer is usually from 80% by mole to 95% by mole, preferably from 88% by mole to 93% by mole, while the content of methacrylic acid units is from 20% by mole to 5% by mole, preferably from 12% by mole to 7% by mole, from the viewpoint of heat resistance.

Besides the styrenic monomer and methacrylic acid, the styrenic monomer-methacrylic acid copolymer may comprise other monomer units. Examples of the other monomer include methacrylates (e.g., methyl methacrylate, ethyl methacrylate, butyl methacrylate, cyclohexyl methacrylate, octadecyl methacrylate, phenyl methacrylate, benzyl methacrylate, 2-ethylhexyl methacrylate, 2-hydroxyethyl methacrylate, adamantyl methacrylate, tricyclodecyl methacrylate, fenchyl methacrylate, norbornyl methacrylate, norbornylmethyl methacrylate, etc.), acrylates (e.g., methyl acrylate, ethyl acrylate, butyl acrylate, cyclohexyl acrylate, phenyl acrylate, benzyl acrylate, 2-ethylhexyl acrylate, 2-hydroxyethyl acrylate, tricyclodecyl acrylate, etc.), unsaturated acids (e.g., acrylic acid, etc.), acrylonitrile, methacrylonitrile, maleic anhydride, phenylmaleimide, cyclohexylmaleimide, glutaric anhydride, glutarimide, and the like. These monomers may be used independently or in a combination of two or more of them.

The styrenic monomer-methacrylic acid copolymer is usually transparent. In the present invention, commercially available styrenic monomer-methacrylic acid copolymers may be used. Examples of the commercially available styrenic monomer-methacrylic acid copolymers include TOYO STYROL® T080 (manufactured by Toyo Styrene Co., Ltd.), Ryulex® A14 (manufactured by Dainippon Ink and Chemicals, Inc.), G9001 (manufactured by PS Japan, Co., Ltd.), and the like.

The light diffuser used in the present invention is a material which can diffuse light passing through the light diffuser plate when it is dispersed in the transparent resin of the light diffuser plate.

The average particle diameter of the light diffuser used in the present invention is usually from 0.6 μm to 1.5 μm, preferably at least 0.65 μm, while it is preferably 1.2 μm or less, more preferably 0.9 μm or less, particularly 0.85 μm or less. If the average particle diameter is neither too small nor too large, the amount of the light diffuser to be added can be reduced.

The standard deviation of the particle diameters of the light diffuser is preferably 0.5 am or less, more preferably 0.2 μm or less. The standard deviation of the particle diameters of the light diffuser may ideally be 0 μm, but it is usually at least 0.01 μm in view of costs.

The amount of the light diffuser to be added to the transparent resin may be arbitrarily selected depending on the absolute value of the refractive index difference |Δn| between the transparent resin and the light diffuser and a total light transmittance required. The amount of the light diffuser is usually from 0.1 to 20 parts by weight, preferably from 0.3 to 3 parts by weight, more preferably from 0.5 to 2 parts by weight, per 100 parts by weight of the transparent resin.

Herein, the average particle diameter and the standard deviation of the particle diameters of the light diffuser are obtained by taking a scanning electron microscopic (SEM) photograph of the light diffuser particles at a magnification of 5,000 times, 10,000 times or 50,000 times, measuring radii of randomly selected 40 particles of the light diffuser by the three point circle radius method, calculating the diameters of the particles, that is, the particle diameters, and then calculating an average particle diameter and a standard deviation of particle diameters from the obtained particle diameters.

The material of the light diffuser used in the present invention may not be particularly limited, and any particles of organic materials or inorganic materials may be used as long as the absolute value of the refractive index difference |Δn| between the transparent resin and the light diffuser is within the range of the present invention. The absolute value of the refractive index difference |Δn| is usually at least 0.05 (|Δn|>0.05), preferably at least 0.10 (|Δn|>0.10). When the refractive index difference is sufficiently large, the amount of the light diffuser can be reduced.

Examples of the inorganic particles include calcium carbonate particles, barium sulfate particles, titanium oxide particles, aluminum hydroxide particles, silica particles, glass particles, talc particles, mica particles, white carbon particles, magnesium oxide particles, zinc oxide particles, etc. The organic particles may be surface treated with a surface-treating agent such as a fatty acid.

Examples of the organic particles include styrenic resin particles, acrylic resin particles, silicone particles, etc. Preferably, acrylic resin particles or silicone particles are used. The styrenic resin particles may be crosslinked styrenic resin particles or high molecular weight styrenic resin particles. The acrylic resin particles may be crosslinked acrylic resin particles or high molecular weight acrylic resin particles. The crosslinked resin particles such as the crosslinked styrenic resin particles and the crosslinked acrylic resin particles mean resin particles having a gel fraction of at least 10% when they are dissolved in acetone at a room temperature (about 25° C.). High molecular weight resin particles such as the high molecular weight styrenic resin particles and the high molecular weight acrylic resin particles means those having a high molecular weight such as a weight average molecular weight of 500,000 to 5,000,000.

Examples of the styrenic resin particles include:

(1) high molecular weight styrenic resin particles prepared by polymerizing a styrenic monomer, or by polymerizing a monomer mixture containing at least 50% by weight of a styrenic monomer and a monomer having one radically polymerizable double bond in the molecule; and
(2) crosslinked styrenic resin particles prepared by polymerizing a monomer mixture containing a styrenic monomer and a monomer having at least two radically polymerizable double bonds in the molecule, or by polymerizing a monomer mixture containing at least 50% by weight of a styrenic monomer, a monomer having one radically polymerizable double bond in the molecule and a monomer having at least two radically polymerizable double bonds in the molecule.

Examples of the styrenic monomer include styrene and its derivatives. Non-limiting examples of the styrene derivatives include halogenated styrenes such as chlorostyrene, bromostyrene, etc.; alkyl-substituted styrenes such as vinyltoluene, α-methylstyrene, etc.; and the like. The styrenic monomers may be used independently or in a combination of two or more of them.

The monomer having one radically polymerizable double bond in the molecule is not particularly limited as long as it is a monomer other than the styrenic monomers. Specific examples of such a monomer include (meth)acrylates such as methyl (meth)acrylate, ethyl (meth)acrylate, butyl (meth)acrylate, cyclohexyl (meth)acrylate, phenyl (meth)acrylate, benzyl (meth)acrylate, 2-ethylhexyl (meth)acrylate, 2-hydroxyethyl (meth)acrylate, etc.; acrylonitrile; and the like. Among them, alkyl acrylates such as methyl acrylate are preferable. These monomers may be used independently or in a combination of two or more of them.

Herein, “(meth)acrylate” means “methacrylate and acrylate”.

The monomer having at least two radically polymerizable double bonds in the molecule is a monomer having two or more radically double bonds and copolymerizable with the monomers described above, except for conjugated dienes. Specific examples of such a monomer include alkyldiol di(meth)acrylates such as 1,4-butanediol di(meth)acrylate, neopentyl glycol di(meth)acrylate, etc.; alkylene glycol di(meth)acrylates such as ethylene glycol di(meth)acrylate, diethylene glycol (meth)acrylate, tetraethyhlene glycol di(meth)acrylate, propylene glycol di(meth)acrylate, tetrapropylene glycol di(meth)acrylate, etc.; polyfunctional aromatic compounds such as divinylbenzene, diallyl phthalate, etc.; di(meth)acrylates of polyhydric alcohols such as trimethylolpropane tri(meth)acrylate, pentaerithritol tetra(meth)acrylate, etc.; and the like. These monomers may be used independently or in a combination of two or more of them.

Examples of the acrylic resin particles include:

(1) high molecular weight acrylic resin particles prepared by polymerizing an acrylic monomer, or by polymerizing a monomer mixture containing at least 50% by weight of an acrylic monomer and a monomer having one radically polymerizable double bond in the molecule; and
(2) crosslinked acrylic resin particles prepared by polymerizing a monomer mixture containing an acrylic monomer and a monomer having at least two radically polymerizable double bonds in the molecule, or by polymerizing a monomer mixture containing at least 50% by weight of an acrylic monomer, a monomer having one radically polymerizable double bond in the molecule and a monomer having at least two radically polymerizable double bonds in the molecule.

Examples of the acrylic monomer include (meth)acrylates (e.g., methyl (meth)acrylate, ethyl (meth)acrylate, butyl (meth)acrylate, cyclohexyl (meth)acrylate, phenyl (meth)acrylate, benzyl (meth)acrylate, 2-ethylhexyl (meth)acrylate, 2-hydroxyethyl (meth)acrylate, etc.), acrylic acid, methacrylic acid, and the like. These acrylic monomers may be used independently or in a combination of two or more of them.

The monomer having one radically polymerizable double bond in the molecule is not particularly limited as long as it is a monomer other than the acrylic monomer. Examples of such a monomer include styrene and styrene derivatives. Specific examples of the styrene derivatives include halogenated styrenes such as chlorostyrene, bromostyrene, etc.; alkyl-substituted styrenes such as vinyltoluene, α-methylstyrene, etc.; and the like. Among them, styrene is preferable. These monomers may be used independently or in a combination of two or more of them.

The monomer having at least two radically polymerizable double bonds in the molecule is a monomer having two or more radically double bonds and copolymerizable with the monomers described above, except for conjugated dienes. Examples of such a monomer include those described above and also allyl (meth)acrylate.

As the acrylic resin particles, core-shell particles having an inner layer and an outer layer may be used.

The inner layer of the core-shell particles may comprise a copolymer obtained by polymerizing a polyfunctional monomer having at least two carbon-carbon double bonds in the molecule in an amount of from 0.1 to 10% by weight, preferably from 0.2 to 5% by weight based on the total weight of all the monomers, and a monofunctional monomer comprising butyl acrylate as a main component. The monofunctional monomer comprising butyl acrylate as a main component means that the monomer contains at least 50% by weight of butyl acrylate and optionally other unsaturated monomer copolymerizable with butyl acrylate.

Specific examples of the polyfunctional monomer include ethylene glycol di(meth)acrylate, 1,3-butylene glycol dimethacrylate, trimethylolpropane triacrylate, pentaerithritol tetraacrylate, divinylbenzene triallylcyanurate, allyl cinnamate, allyl (meth)acrylate, allyl sorbate, diallyl phthalate, diallyl maleate, etc. Preferably, allyl (meth)acrylate is used.

The outer layer of the core-shell particles may comprise a copolymer obtained by polymerizing a monofunctional monomer comprising methyl methacrylate as a main component. The outer layer may be a monolayer or optionally a multilayer having two or more layers. The monofunctional monomer comprising methyl methacrylate as a main component means that the monomer contains at least 50% by weight of methyl methacrylate and optionally other ethylenically unsaturated monomer copolymerizable with methyl methacrylate.

In the core-shell particles, the weight ratio of the inner layer to the outer layer is usually from 1:9 to 9:1. The styrenic resin particles and the acrylic resin particles may be produced by polymerizing the monomer or monomers by a conventional polymerization method such as suspension polymerization, microsuspension polymerization, emulsion polymerization, dispersion polymerization, etc. The core-shell particles may be easily produced by a successive two-step polymerization method based on emulsion polymerization. That is, firstly an inner layer constituting a core is formed by emulsion polymerization and then an outer layer is formed by emulsion polymerization in the presence of the inner layer.

The particle shape of the light diffuser is not particularly limited, although spherical particles are preferable.

The thickness of the light diffuser plate of the present invention is not limited. It is usually 5 mm or less, preferably 3 mm or less, while it is usually at least 0.8 mm, preferably at least 1 mm, in view of the strength of the plate.

The light diffuser plate of the present invention may optionally contain any of conventional additives. Specific examples of the additives include antistatic agents (e.g., sodium alkylsulfonates, sodium alkylsulfates, stearic acid monoglyceride, polyetherester amide, etc.), antioxidants (e.g., hindered phenol, etc.), flame retardants (e.g., phosphoric acid esters, etc.), lubricants (e.g., palmitic acid, stearyl alcohol, etc.), light stabilizers (e.g., hindered amines, etc.), antioxidants (e.g., hindered phenols, etc.), dyes, optical brighteners, processing stabilizers, UV absorbers (e.g., benzotriazole UV absorbers, benzophenone UV absorbers, cyanoacrylate UV absorbers, malonate UV absorbers, oxanilide UV absorbers, acetate UV absorbers, triazine UV absorbers, salicylate UV absorbers, benzoate UV absorbers, etc.), and the like. These additives may be used independently or in a combination of two or more of them.

The light diffuser plate of the present invention may be produced by melt kneading a transparent resin and a light diffuser with a ribbon blender, a Henschel mixer, a Banbury mixer, a drum tumbler, a single screw extruder, a twin screw extruder, a multi-screw extruder, etc., and extruding the resulting melt through a die to form a plate. When the light diffuser plate contains additives, they are usually melt kneaded together with the transparent resin and the light diffuser. Alternatively, the light diffuser plate of the present invention may be produced by an injection molding method, in which the melt prepared in the above melt kneading step is injected in an injection mold.

The light diffuser plate of the present invention may optionally have a UV absorbing layer comprising a transparent resin and a UV absorber on at least one surface of the plate and may be used as a multilayer light diffuser plate. Such a multilayer light diffuser plate can prevent the deterioration of the plate caused by ultraviolet ray. As the UV absorber to be contained in the UV absorbing layer may be a conventional UV absorber, and examples thereof include benzotriazole UV absorbers, benzophenone UV absorbers, cyanoacrylate UV absorbers, malonate UV absorbers, oxanilide UV absorbers, acetate UV absorbers, triazine UV absorbers, salicylate UV absorbers, benzoate UV absorbers, etc.

As a transparent resin comprised in the UV absorbing layer, a methyl methacrylate resin or a styrenic resin is preferably used, and a methyl methacrylate-styrene copolymer is more preferably used.

The methyl methacrylate resin means a polymer comprising at least 50% by weight of methyl methacrylate units based on the monomer units constituting the methyl methacrylate resin, and may be a homopolymer of methyl methacrylate, or a copolymer comprising 50% by weight or more of methyl methacrylate and 50% by weight or less of other monomer copolymerizable with methyl methacrylate.

Examples of the other monomer copolymerizable with methyl methacrylate include methacrylates except methyl methacrylate (e.g., ethyl methacrylate, butyl methacrylate, cyclohexyl methacrylate, octadecyl methacrylate, phenyl methacrylate, benzyl methacrylate, 2-ethylhexyl methacrylate, 2-hydroxyethyl methacrylate, adamantyl methacrylate, tricyclodecyl methacrylate, fenchyl methacrylate, norbornyl methacrylate, norbornylmethyl methacrylate, etc.), acrylates (e.g., methyl acrylate, ethyl acrylate, butyl acrylate, cyclohexyl acrylate, phenyl acrylate, benzyl acrylate, 2-ethylhexyl acrylate, 2-hydroxyethyl acrylate, tricyclodecyl acrylate, etc.), unsaturated acids (e.g., methacrylic acid, acrylic acid, etc.), acrylonitrile, methacrylonitrile, maleic anhydride, phenylmaleimide, cyclohexylmaleimide, glutaric anhydride, glutarimide, styrenic monomers, and the like. These monomers may be used independently or in a combination of two or more of them. As the styrenic monomers, substituted styrenes may be used besides styrene. The methyl methacrylate may comprise glutaric anhydride units or glutarimide units.

The styrenic resin means a resin comprising from 50 to 100% by weight of styrenic monomer units based on the monomer units constituting the styrenic resin. As the styrenic monomers, substituted styrenes may be used besides styrene. Examples of the substituted styrene include halogenated styrenes such as chlorostyrene, bromostyrene, etc.; alkyl-substituted styrenes such as vinyltoluene, α-methylstyrene, etc.; and the like. The styrenic monomers may be used independently or in a combination of two or more of them.

Examples of other monomers which may constitute the styrenic resin include methyl methacrylate and monomers which are exemplified as the other monomers optionally constituting the methyl methacrylate resin described above except for styrene.

The methyl methacrylate resin or the styrenic resin comprised in the UV absorbing layer may be a copolymer of styrene and methyl methacrylate, i.e., a methyl methacrylate-styrene copolymer. The content of styrene units in the methyl methacrylate-styrene copolymer is usually from 5% by weight to 95% by weight, while that of methyl methacrylate units is usually from 95% by weight to 5% by weight.

The light diffuser plate of the present invention comprises the light diffuser defined above in the transparent resin. Therefore, it can decrease the total light transmittance of the transparent resin even when the content of the light diffuser is low. The light diffuser plate of the present invention can sufficiently diffuse the light passing therethrough with the small amount of the light diffuser, since the transparent resin, the total light transmittance of which is decreased by the light diffuser, can well diffuse the light passing through the resin. Accordingly, the present invention also provides a method for decreasing a total light transmittance of d transparent resin comprising adding the light diffuser which is used in the light diffuser plate according to the present invention.

### EXAMPLES

The present invention will be illustrated by the following Examples, which do not limit the scope of the present invention in any way. In the Examples, “%” and “parts” are based on weight unless otherwise indicated.

Measurement of Total Light Transmittance

A total light transmittance Tt is measured using a haze transmittance meter (HR-100 manufactured by MUPAKAMI COLOR RESEARCH LABORATORY CO., LTD.) according to JIS K 7361.

Measurement of Particle Diameter

The particles of a light diffuser are press-fixed on a sample stage and carbon is vapor deposited thereon to prepare a sample piece. The SEM photograph of the light diffuser particles on the sample piece is taken using a field-emission scanning electron microscope (FE-SEM S-420 manufactured by Hitachi Limited) with selecting a magnification suitable for respective particle diameters from 5,000 times, 10,000 times and 50,000 times. Then, the radius of each particle of the light diffuser is measured by the three point circle radius method and the diameter of the particle is calculated from the radius measured.

Average Particle Diameter and Standard Deviation of Particle Diameter

In the above measurement method of the particle diameter, 40 particles are randomly selected and the diameters of those particles are calculated. Then, the average value and the standard deviation of the particle diameters of the light diffuser are calculated.

### Comparative Example 1

To 100 parts of polystyrene (HRM 40 manufactured by Toyo Styrene Co., Ltd.; refractive index: 1.59), 1 part of silicone particles having a refractive index of 1.43, an average particle diameter of 2.49 μm and a standard deviation of particle diameters of 0.14 μm were added and dry blended to obtain a resin composition. The resin composition was then extrusion molded using a 40 mm single screw extruder equipped with a multi-manifold die (manufactured by Tanabe Plastics Co., Ltd.) in a temperature range of from 190 to 260° C. to obtain a single-layer light diffuser plate having a thickness of 2 mm. The single-layer light diffuser plate had a total light transmittance (hereinafter referred to as “Tt”) of 56.2%.

### Comparative Example 2

A single-layer light diffuser plate was produced in the same manner as in COMPARATIVE EXAMPLE 1 except that, to 100 parts of polystyrene (HRM 40 manufactured by Toyo styrene Co., Ltd.; refractive index: 1.59), 1 part of silicone particles having a refractive index of 1.43, an average particle diameter of 2.17 μm and a standard deviation of particle diameters of 0.29 μm were added. The single-layer light diffuser plate having a thickness of 2 mm had Tt of 54.8%.

### Example 1

A single-layer light diffuser plate was produced in the same manner as in COMPARATIVE EXAMPLE 1 except that, to 100 parts of polystyrene (HRM 40 manufactured by Toyo Styrene Co., Ltd.; refractive index: 1.59), 1 part of silicone particles having a refractive index of 1.43, an average particle diameter of 0.67 μm and a standard deviation of particle diameters of 0.07 μm were added. The single-layer light diffuser plate having a thickness of 2 mm had Tt of 49.6%.

### Comparative Example 3

A single-layer light diffuser plate was produced in the same manner as in COMPARATIVE EXAMPLE 1 except that, to 100 parts of polystyrene (HRM 40 manufactured by Toyo Styrene Co., Ltd.; refractive index: 1.59), 1 part of silicone particles having a refractive index of 1.43, an average particle diameter of 0.12 μm and a standard deviation of particle diameters of 0.01 μm were added. The single-layer light diffuser plate having a thickness of 2 mm had Tt of 55.0%.

### Comparative Example 4

A single-layer light diffuser plate was produced in the same manner as in COMPARATIVE EXAMPLE 1 except that, to 100 parts of polystyrene (HRM 40 manufactured by Toyo Styrene Co., Ltd.; refractive index: 1.59), 1 part of acrylic resin particles having a refractive index of 1.49, an average particle diameter of 2.44 μm and a standard deviation of particle diameters of 0.52 μm were added. The single-layer light diffuser plate having a thickness of 2 mm had Tt of 69.3%.

### Example 2

A single-layer light diffuser plate was produced in the same manner as in COMPARATIVE EXAMPLE 1 except that, to 100 parts of polystyrene (HRM 40 manufactured by Toyo Styrene Co., Ltd.; refractive index: 1.59), 1 part of acrylic resin particles having a refractive index of 1.49, an average particle diameter of 0.85 μm and a standard deviation of particle diameters of 0.03 μm were added. The single-layer light diffuser plate having a thickness of 2 mm had Tt of 55.1%.

### Comparative Example 5

A single-layer light diffuser plate was produced in the same manner as in COMPARATIVE EXAMPLE 1 except that, to 100 parts of polystyrene (HRM 40 manufactured by Toyo 15. Styrene Co., Ltd.; refractive index: 1.59), 1 part of acrylic resin particles having a refractive index of 1.49, an average particle diameter of 0.50 μm and a standard deviation of particle diameters of 0.04 μm were added. The single-layer light diffuser plate having a thickness of 2 mm had Tt of 70.2%.

The results are summarized in Table 1.

TABLE 1

| | Comp. | Comp. | | | Comp. | | Comp. |
|---|---|---|---|---|---|---|---|
| | Ex. 1 | Ex. 2 | Ex. 1 | Ex. 2 | Ex. 4 | Ex. 3 | Ex. 5 |
| Average | 2.49 | 2.17 | 0.67 | 0.12 | 2.44 | 0.85 | 0.50 |
| particle | | | | | | | |
| diameter | | | | | | | |
| (μm) | | | | | | | |
| Standard | 0.14 | 0.29 | 0.07 | 0.02 | 0.52 | 0.03 | 0.04 |
| deviation of | | | | | | | |
| particle | | | | | | | |
| diameters | | | | | | | |
| (μm) | | | | | | | |
| Tt¹⁾ (%) | 56.2 | 54.8 | 49.6 | 55.0 | 69.3 | 55.1 | 70.2 |

Note:
¹⁾Tt when 1 part of a light diffuser was added to 100 parts of a transparent resin (polystyrene).

### Example 3

To 100 parts of a styrene-methacrylic acid copolymer (TOYO STYROL® TOBO (manufactured by Toyo Styrene Co., Ltd.; refractive index: 1.59; styrene unit content: 90% by mole and methacrylic acid unit content: 10% by mole (analyzed by NMR)), 1 part of crosslinked acrylic resin particles having a refractive index of 1.48, an average particle diameter of 1.00 μm and a standard deviation of particle diameters of 0.05 μm were added and dry blended to obtain a resin composition. The resin composition was then extrusion molded using a 40 mm single screw extruder equipped with a multi-manifold die (manufactured by Tanabe Plastics Co., Ltd.) in a temperature range of from 190 to 260° C. to obtain a light diffuser plate having a thickness of 2 mm. The light diffuser plate had Tt of 58.8%.

A light diffuser plate having a thickness of 2 mm was produced in the same manner as above except that the amount of the crosslinked acrylic resin particles was changed to 1.5 parts or 2.5 parts. It had Tt of 54.3% or 50.5%, respectively.

### Comparative Example 6

A light diffuser plate having a thickness of 2 mm was produced in the same manner as in EXAMPLE 3 except that 1 part of crosslinked acrylic resin particles having a refractive index of 1.49, an average particle diameter of 2.44 μm and a standard deviation of particle diameters of 0.52 μm was used in place of the crosslinked acrylic resin particles of EXAMPLE 3. The light diffuser plate had Tt of 78.0%.

A light diffuser plate having a thickness of 2 mm was produced in the same manner as above except that the amount of the crosslinked acrylic resin particles was changed to 1.5 parts or 2.5 parts. It had Tt of 69.1% or 60.1%, respectively.

### Example 4

A light diffuser plate having a thickness of 2 mm was produced in the same manner as in EXAMPLE 3 except that 1 part of crosslinked acrylic resin particles having a refractive index of 1.49, an average particle diameter of 0.85 pin and a standard deviation of particle diameters of 0.03 μm was used in place of the crosslinked acrylic resin particles of EXAMPLE 3. The light diffuser plate had Tt of 57.8%.

### Example 5

A light diffuser plate having a thickness of 2 mm was produced in the same manner as in EXAMPLE 3 except that 1 part of silicone particles having a refractive index of 1.49, an average particle diameter of 0.72 μm and a standard deviation of particle diameters of 0.07 μm was used in place of the crosslinked acrylic resin particles of Example 3. The light diffuser plate had Tt of 51.1%.

A light diffuser plate having a thickness of 2 mm was produced in the same manner as above except that the amount of the silicone particles was changed to 1.5 parts or 2.5 parts. It had Tt of 43.4% or 38.9%, respectively.

### Example 6

A light diffuser plate having a thickness of 2 mm was produced in the same manner as in EXAMPLE 3 except that 1 part of crosslinked acrylic resin particles having a refractive index of 1.49, an average particle diameter of 0.82 μm and a standard deviation of particle diameters of 0.02 μm was used in place of the crosslinked acrylic resin particles of EXAMPLE 3. The light diffuser plate had Tt of 57.7%.

A light diffuser plate having a thickness of 2 mm was produced in the same manner as above except that the amount of the crosslinked acrylic resin particles was changed to 1.5 parts or 2.5 parts. It had Tt of 54.6% or 51.1%, respectively.

### Example 7

A light diffuser plate having a thickness of 2 mm was produced in the same manner as in EXAMPLE 3 except that 1 part of crosslinked acrylic resin particles having a refractive index of 1.49, an average particle diameter of 0.64 μm and a standard deviation of particle diameters of 0.04 μm was used in place of the crosslinked acrylic resin particles of EXAMPLE 3. The light diffuser plate had Tt of 57.2%.

A light diffuser plate having a thickness of 2 mm was produced in the same manner as above except that the amount of the crosslinked acrylic resin particles was changed to 1.5 parts or 2.5 parts. It had Tt of 54.3% or 50.4%, respectively.

### Example 8

### Preparation of Light Diffuser Masterbatch A

0.04 Part of an oxazole optical brightener (WHITE FLOW® PSN conc manufactured by SUMIKA COLOR CO., LTD.) was added to a mixture of 83.96 parts of a styrene-methacrylic acid copolymer (TOYO STYROL® T080 manufactured by Toyo Styrene Co., Ltd.), 14.0 parts of the same crosslinked acrylic resin particles as those used in EXAMPLE 3, 1.0 part of a UV absorber (SUMISORB® 200 manufactured by Sumitomo Chemical Co., Ltd.) and a processing stabilizer (SUMIRIZER® GP manufactured by Sumitomo Chemical Co., Ltd.), and dry blended. Then, the compound was pelletized using a twin screw extruder in a temperature range of from 190 to 250° C. to obtain Light Diffuser Masterbatch A in the pellet form.

Preparation of UV Absorber Compound A

90.55 Parts of a styrene-methyl methacrylate copolymer (Estyrene® MS200NT manufactured by Nippon Steel Chemical Co., Ltd.; styrene unit content: 80%; methyl methacrylate unit content: 20%), 8.0 parts of crosslinked acrylic resin particles (refractive index: 1.49; average particle diameter: 30 μm), 0.2 part of a processing stabilizer (SUMIRIZER® GP manufactured by Sumitomo Chemical Co., Ltd.), 1.0 part of a UV absorber (TINUVIN® 1577 manufactured by Ciba Specialty Chemicals Inc.) and 0.25 part of a processing stabilizer (MONOGLY D manufactured by NOF Corporation) were dry blended. Then, the mixture was pelletized using a twin screw extruder in a temperature range of from 200 to 250° C. to obtain UV Absorber Compound A in the pellet form.

Production of Multilayer Light Diffuser Plate

90 Parts of a styrene-methacrylic acid copolymer (TOYO STYROL® T080 manufactured by Toyo Styrene Co., Ltd.) and 10 parts of Light Diffuser Masterbatch A prepared in the above were dry blended. Then, the blend was supplied to an extruder having a screw diameter of 120 mm and melt kneaded at a temperature of 200 to 250° C. Separately, UV Absorber Compound A prepared in the above was supplied to an auxiliary extruder having a screw diameter of 45 mm and melt kneaded at a temperature of 210 to 250° C. Then, the melt of the blend of the styrene-methacrylic acid copolymer and Light Diffuser Masterbatch A, and the melt of UV Absorber Compound A were co-extruded through a feed block and a T die at a T die temperature of 245 to 255° C. to obtain a three-layer optical diffuser plate comprising a light diffuser plate having a thickness of 1.86 mm and UV absorbing layers each having a thickness of 0.07 mm laminated on the both surfaces of the diffuser plate. This multilayer light diffuser plate had Tt of 53.4%.

### Example 9

### Production of Multilayer Light Diffuser Plate

97 Parts of a styrene-methacrylic acid copolymer (TOYO STYROL® T080 manufactured by Toyo Styrene Co., Ltd.) and 3.0 parts of Light Diffuser Masterbatch A prepared in EXAMPLE 8 were dry blended. Then, the blend was supplied to an extruder having a screw diameter of 120 mm and melt kneaded at a temperature of 200 to 250° C. Separately, UV Absorber Compound A prepared in EXAMPLE 8 was supplied to an auxiliary extruder having a screw diameter of 45 mm and melt kneaded at a temperature of 210 to 250° C. Then, the melt of the blend of the styrene-methacrylic acid copolymer and Light Diffuser Masterbatch A, and the melt of UV Absorber Compound A were co-extruded through a feed block and a T die at a T die temperature of 245 to 255° C. to obtain a three-layer optical diffuser plate comprising a light diffuser plate having a thickness of 1.86 mm and UV absorbing layers each having a thickness of 0.07 mm laminated on the both surfaces of the diffuser plate. This multilayer light diffuser plate had Tt of 60.6%.

### Example 10

### Preparation of UV Absorber Compound B

90.55 Parts of a styrene-methyl methacrylate copolymer (Estyrene® MS200NT manufactured by Nippon Steel Chemical Co., Ltd.; styrene unit content: 80%; methyl methacrylate unit content: 20%), 8.0 parts of crosslinked acrylic resin particles (refractive index: 1.49; average particle diameter: 30 μm), 0.2 part of a processing stabilizer (SUMIRIZER® GP manufactured by Sumitomo Chemical Co., Ltd.), 1.0 part of a UV absorber (LA 31 manufactured by ADEKA CORPORATION) and 0.25 part of a processing stabilizer (MONOGLY D manufactured by NOF Corporation) were dry blended. Then, the blend was pelletized using a twin screw extruder in a temperature range of from 200 to 250° C. to obtain UV Absorber Compound B in the pellet form.

Production of Multilayer Light Diffuser Plate

96.8 Parts of a styrene-methacrylic acid copolymer (TOYO STYROL® T080 manufactured by Toyo Styrene Co., Ltd.) and 3.2 parts of Light Diffuser Masterbatch A prepared in EXAMPLE 8 were dry blended. Then, the blend was supplied to an extruder having a screw diameter of 120 mm and melt kneaded at a temperature of 200 to 250° C. Separately, UV Absorber Compound B prepared in the above was supplied to an auxiliary extruder having a screw diameter of 45 mm and melt kneaded at a temperature of 210 to 250° C. Then, the melt of the blend of the styrene-methacrylic acid copolymer and Light Diffuser Masterbatch A, and the melt of UV Absorber Compound B were co-extruded through a feed block and a T die at a T die temperature of 245 to 255° C. to obtain a three-layer optical diffuser plate comprising a light diffuser plate having a thickness of 2.86 mm and UV absorbing layers each having a thickness of 0.07 mm laminated on the both surfaces of the diffuser plate. This multilayer light diffuser plate having a total thickness of 3 mm had Tt of 53.5%.

### Example 11

### Production of Multilayer Light Diffuser Plate

88.0 Parts of a styrene-methacrylic acid copolymer (TOYO STYROL® T080 manufactured by Toyo Styrene Co., Ltd.) and 12.0 parts of Light Diffuser Masterbatch A prepared in EXAMPLE 8 were dry blended. Then, the blend was supplied to an extruder having a screw diameter of 120 mm and melt kneaded at a temperature of 200 to 250° C. Separately, UV Absorber Compound B prepared in EXAMPLE 9 was supplied to an auxiliary extruder having a screw diameter of 45 mm and melt kneaded at a temperature of 210 to 250° C. Then, the melt of the blend of the styrene-methacrylic acid copolymer and Light Diffuser Masterbatch A, and the melt of UV Absorber Compound B were co-extruded through a feed block and a T die at a T die temperature of 245 to 255° C. to obtain a three-layer optical diffuser plate comprising a light diffuser plate having a thickness of 1.61 mm and UV absorbing layers each having a thickness of 0.07 mm laminated on the both surfaces of the diffuser plate. This multilayer light diffuser plate having a total thickness of 1.75 mm had Tt of 52.4%.

### Example 12

### Preparation of Light Diffuser Masterbatch B

0.05 Part of an oxazole optical brightener (WHITE FLOW® PSN conc manufactured by SUMIKA COLOR CO., LTD.) was added to a mixture of 83.95 parts of a styrene-methacrylic acid copolymer (TOYO STYROL® T080 manufactured by Toyo Styrene Co., Ltd.), 14.0 parts of the same crosslinked acrylic resin particles as those used in EXAMPLE 3, 1.0 part of a UV absorber (SUMISORB® 200 manufactured by Sumitomo Chemical Co., Ltd.) and 1.0 part of a processing stabilizer (SUMIRIZER® GP manufactured by Sumitomo Chemical Co., Ltd.), and dry blended. Then, the compound was pelletized using a twin screw extruder in a temperature range of from 190 to 250° C. to obtain Light Diffuser Masterbatch B in the pellet form.

Production of Multilayer Light Diffuser Plate

90 Parts of a styrene-methacrylic acid copolymer (TOYO STYROL® T080 manufactured by Toyo Styrene Co., Ltd.) and 10.0 parts of Light Diffuser Masterbatch B prepared in the above were dry blended. Then, the blend was supplied to an extruder having a screw diameter of 120 mm and melt kneaded at a temperature of 200 to 250° C. Separately, UV Absorber Compound B prepared in EXAMPLE 10 was supplied to an auxiliary extruder having a screw diameter of 45 mm and melt kneaded at a temperature of 210 to 250° C. Then, the melt of the blend of the styrene-methacrylic acid copolymer and Light Diffuser Masterbatch B, and the melt of UV Absorber Compound B were co-extruded through a feed block and a T die at a T die temperature of 245 to 255° C. to obtain a three-layer optical diffuser plate comprising a light diffuser plate having a thickness of 1.36 mm and UV absorbing layers each having a thickness of 0.07 mm laminated on the both surfaces of the diffuser plate. This multilayer light diffuser plate having a total thickness of 1.5 mm had Tt of 58.6%.

The results of EXAMPLES 3-7 and COMPARATIVE EXAMPLE 6 are summarized in TABLE 2.

TABLE 2

| | Example No. | | | | | |
|---|---|---|---|---|---|---|
| | 3 | C. 6 | 4 | 5 | 6 | 7 |
| Average | 1.00 | 2.44 | 0.85 | 0.72 | 0.82 | 0.64 |
| particle | | | | | | |
| diameter | | | | | | |
| (μm) | | | | | | |
| Standard | 0.05 | 0.52 | 0.03 | 0.07 | 0.02 | 0.04 |
| deviation of | | | | | | |
| particle | | | | | | |
| diameter | | | | | | |
| (μm) | | | | | | |
| Tt¹⁾ (%) | | | | | | |
| 1.0 part | 58.8 | 78.0 | 57.8 | 51.1 | 57.7 | 57.2 |
| 1.5 parts | 54.3 | 69.1 | — | 43.4 | 54.6 | 54.3 |
| 2.5 parts | 50.0 | 60.1 | — | 38.9 | 51.1 | 50.4 |

Note:
¹⁾A total light transmittance with the addition of a diffuser in an amount specified.

The results of EXAMPLES 8-12 are summarized in TABLE

TABLE 3

| | Example No. | | | | |
|---|---|---|---|---|---|
| | 8 | 9 | 10 | 11 | 12 |
| Average | 1.00 | 1.00 | 1.00 | 1.00 | 1.00 |
| particle | | | | | |
| diameter | | | | | |
| (μm) | | | | | |
| Standard | 0.05 | 0.05 | 0.05 | 0.05 | 0.05 |
| deviation of | | | | | |
| particle | | | | | |
| diameter | | | | | |
| (μm) | | | | | |
| Thickness | 2.0 | 2.0 | 3.0 | 1.75 | 1.5 |
| (mm) | | | | | |
| Amount of | 1.42 | 0.42 | 0.45 | 1.68 | 1.40 |
| diffuser | | | | | |
| (parts) | | | | | |
| Tt (%) | 53.4 | 60.6 | 53.5 | 52.4 | 58.6 |

What is claimed is:

1. A light diffuser plate comprising a transparent resin composition which comprises a transparent resin and a light diffuser wherein the light diffuser has an average particle diameter of from 0.6 μm to 1.5 μm and a standard deviation of particle diameters of from 0.01 μm to 0.5 μm, and an absolute value of a refractive index difference |Δn| between the transparent resin and the light diffuser is at least 0.05.

2. The light diffuser plate according to claim 1, wherein said transparent resin is polystyrene.

3. The light diffuser plate according to claim 1, wherein said transparent resin is a styrenic monomer-methacrylic acid copolymer.

4. The light diffuser plate according to claim 1, wherein said light diffuser has an average particle diameter of from 0.6 μm to 0.9 μm.

5. The light diffuser plate according to claim 1, wherein said light diffuser is at least one light diffuser selected from styrenic resin particles, acrylic resin particles and silicone particles.

6. The light diffuser plate according to claim 1, wherein an amount of said light diffuser is from 0.3 part by weight to 3 parts by weight based on 100 parts by weight of the transparent resin.

7. A multilayer light diffuser plate comprising the light diffuser plate according to claim 1 and a UV absorbing layer comprising a transparent resin and a UV absorber laminated on at least one surface of said light diffuser plate according to claim 1.

8. The multilayer light diffuser plate according to claim 7, wherein said transparent resin comprised in said UV absorbing layer is at least one resin selected from methyl methacrylate resins and styrenic resins.

9. The multilayer light diffuser plate according to claim 7, wherein said transparent resin comprised in said UV absorbing layer is a methyl methacrylate-styrene copolymer.

10. A method for decreasing a total light transmittance of a transparent resin comprising adding a light diffuser to the transparent resin, wherein said light diffuser has an average particle diameter of from 0.6 μm to 1.5 μm and a standard deviation of particle diameters of from 0.01 μm to 0.5 μm, and an absolute value of a refractive index difference |Δn| between the transparent resin and the light diffuser is at least 0.05.
